(19) United States
(12) Patent Application Publication
(10) Pub. No.: US 2006/0168432 A1
(43) Pub. Date: Jul. 27, 2006

(54) Branch prediction accuracy in a processor that supports speculative execution

(76) Inventors: Paul Caprioli, Mountain View, CA (US); Sherman H. Yip, San Francisco, CA (US); Shailender Chaudhry, San Francisco, CA (US)

Correspondence Address: SUN MICROSYSTEMS INC.;C/O PARK, VAUGHAN & FLEMING LLP, 2820 FIFTH STREET, DAVIS, CA, 95616, US

(21) Appl. No.: 11/042,687

(22) Filed: Jan. 24, 2005

(51) Int. Cl. G06F 9/00

(52) U.S. Cl. 712/235; 712/239

(57) ABSTRACT

One embodiment of the present invention provides a system which improves branch prediction accuracy in a processor that supports speculative-execution. During normal-execution mode, the system issues instructions in program order. Upon encountering a launch condition which causes a processor to enter a speculative-execution mode, the system performs a checkpoint and begins executing instructions in a speculative-execution mode. Upon encountering a branch instruction during speculative-execution mode, the system selects the subsequent instruction to be executed based on a current state of a branch predictor and does not update the current state of the branch predictor, thereby preventing the branch predictor from being incorrectly updated twice when re-executing the branch instruction after returning to normal-execution mode.

### BACKGROUND

1. Field of the Invention

The present invention relates to techniques for improving the performance of computer systems. More specifically, the present invention relates to a method and apparatus for improving branch prediction accuracy in a processor that supports speculative execution.

2. Related Art

Advances in semiconductor fabrication technology have given rise to dramatic increases in microprocessor clock speeds. This increase in microprocessor clock speeds has not been matched by a corresponding increase in memory access speeds. Hence, the disparity between microprocessor clock speeds and memory access speeds continues to grow, and is beginning to create significant performance problems. Execution profiles for fast microprocessor systems show that a large fraction of execution time is spent not within the microprocessor core, but within memory structures outside of the microprocessor core. This means that the microprocessor systems spend a large fraction of time waiting for memory references to complete instead of performing computational operations.

When a memory reference, such as a load operation, generates a cache miss, the subsequent access to level-two (L2) cache (or memory) can require dozens or hundreds of clock cycles to complete, during which time the processor is typically idle, performing no useful work.

A number of techniques are presently used (or have been proposed) to hide this cache-miss latency. Some processors support out-of-order execution, in which instructions are kept in an issue queue, and are issued “out-of-order” when operands become available. Unfortunately, existing out-of-order designs have a hardware complexity that grows quadratically with the size of the issue queue. Practically speaking, this constraint limits the number of entries in the issue queue to one or two hundred, which is not sufficient to hide memory latencies as processors continue to get faster. Moreover, constraints on the number of physical registers that can be used for register renaming purposes during out-of-order execution also limit the effective size of the issue queue.

Some processor designers have proposed using speculative-execution to avoid the pipeline stalls associated with cache misses. Two such proposed speculative-execution modes are: (1) execute-ahead mode and (2) scout mode.

Execute-ahead mode operates as follows. During normal execution, the system issues instructions for execution in program order. Upon encountering an unresolved data dependency during execution of an instruction, the system generates a checkpoint that can be used to return execution of the program to the point of the instruction. Next, the system executes subsequent instructions in the execute-ahead mode, wherein instructions that cannot be executed because of an unresolved data dependency are deferred, and wherein other non-deferred instructions are executed in program order.

If the unresolved data dependency is resolved during execute-ahead mode, the system enters a deferred execution mode, wherein the system executes deferred instructions. If all deferred instructions are executed during this deferred execution mode, the system returns to normal-execution mode to resume normal program execution from the point where the execute-ahead mode left off. Alternatively, if all deferred instructions are not executed, the system returns to execute-ahead mode until the remaining unresolved data dependencies are resolved and the deferred instructions can be executed.

If the system encounters a non-data-dependent stall condition while executing in normal mode or execute-ahead mode, the system moves to a scout mode. In scout mode, instructions are speculatively executed to prefetch future loads, but results are not committed to the architectural state of the processor. When the launch point stall condition (the unresolved data dependency or the non-data dependent stall condition that originally caused the system to move out of normal-execution mode) is finally resolved, the system uses the checkpoint to resume execution in normal mode from the launch point instruction (the instruction that originally encountered the launch point stall condition).

By allowing a processor to continue to perform work during stall conditions, speculative-execution can significantly increase the amount of work the processor completes.

Unfortunately certain operations, such as branch instructions, can be adversely affected by speculative-execution. To prevent the processor from stalling during a branch operation, designers have optimized processors so that the processor performs a “branch prediction,” which allows the processor to fetch the next instruction before the result of the branch instruction is actually determined. In order to fetch the next instruction, the processor uses historical information for the branch instruction to predict how the branch will be resolved. When the prediction is correct, this method significantly improves processor performance. Otherwise, if the branch is mispredicted, the processor stalls and must restart execution with the actual resolved branch target.

During speculative-execution, a problem can arise when the processor updates the branch prediction mechanism once during speculative-execution and then incorrectly updates the branch prediction a second time upon resuming normal-execution. This duplication of updates to the branch prediction can cause the processor to subsequently mispredict the branch, thereby causing considerable performance degradation.

Hence, what is needed is a mechanism to improve branch prediction accuracy in a processor which supports speculative-execution.

### SUMMARY

One embodiment of the present invention provides a system which improves branch prediction accuracy in a processor that supports speculative-execution. During normal-execution mode, the system issues instructions in program order. Upon encountering a launch condition which causes a processor to enter a speculative-execution mode, the system performs a checkpoint and begins executing instructions in a speculative-execution mode. Upon encountering a branch instruction during speculative-execution mode, the system selects the subsequent instruction to be executed based on a current state of a branch predictor and updates the branch prediction only from weakly-not-taken to weakly-taken or from weakly-taken to weakly-not-taken during speculative-execution mode. Note that updating the branch predictor in this fashion prevents the branch predictor from being incorrectly updated twice when re-executing the branch instruction after returning to normal-execution mode.

In a further variation, the system also updates the branch prediction only from weakly-taken to strongly-taken or from weakly-not-taken to strongly-not-taken.

In a variation of this embodiment, during normal-execution mode, the system updates the branch predictor whenever the system executes the branch instruction.

In a variation of this embodiment, the launch condition is a stall condition and the corresponding speculative-execution mode is a scout mode. During scout mode, instructions are speculatively executed to prefetch future loads, but the results are not committed to the architectural state of the processor.

In a further variation, the stall condition can include a load miss stall; a store buffer full stall; and a memory barrier stall.

In a variation of this embodiment, the launch condition is an unresolved data dependency encountered while executing the launch-point instruction and the corresponding speculative-execution mode is an execute-ahead mode. During execute-ahead mode, instructions that cannot be executed because of an unresolved data dependency are deferred, and other non-deferred instructions are executed in program order.

In a further variation, the unresolved data dependency can include: a use of an operand that has not returned from a preceding load miss; a use of an operand that has not returned from a preceding translation lookaside buffer (TLB) miss; a use of an operand that has not returned from a preceding full or partial read-after-write (RAW) from store buffer operation; and a use of an operand that depends on another operand that is subject to an unresolved data dependency.

In a variation of this embodiment, the system returns to normal-execution mode upon encountering a condition that causes the system to exit speculative-execution mode.

One embodiment of the present invention provides a system which improves branch prediction accuracy in a processor that supports speculative-execution. During normal-execution mode, the system issues instructions in program order. Upon encountering a launch condition which causes a processor to enter a speculative-execution mode, the system performs a checkpoint and begins executing instructions in a speculative-execution mode. Upon encountering a branch instruction during speculative-execution mode, the system selects the subsequent instruction to be executed based on a current state of a branch predictor and leaves the branch predictor in the current state. Note that leaving the branch predictor in the current state prevents the branch predictor from being incorrectly updated twice when re-executing the branch instruction after returning to normal-execution mode.

### BRIEF DESCRIPTION OF THE FIGURES

FIG. 1 illustrates the design of a processor that supports speculative-execution in accordance with an embodiment of the present invention.

FIG. 2 presents a state diagram which includes a general depiction of execute-ahead mode, scout mode, and deferred mode in accordance with an embodiment of the present invention.

FIG. 3A illustrates a sequence of instructions in accordance with an embodiment of the present invention.

FIG. 3B illustrates an entry in a branch prediction table corresponding with the sequence of instructions in FIG. 3A in accordance with an embodiment of the present invention.

FIG. 4 presents a flow chart illustrating how the processor handles a branch instruction during normal-execution mode in accordance with an embodiment of the present invention.

FIG. 5 presents a flow chart illustrating how the processor handles a branch instruction during speculative-execution in accordance with an embodiment of the present invention.

FIG. 6A presents a state diagram for a branch prediction in normal-execution mode in accordance with an embodiment of the present invention.

FIG. 6B presents a state diagram for a branch prediction in normal-execution mode in accordance with an embodiment of the present invention.

FIG. 6C presents a state diagram for a branch prediction in speculative-execution mode in accordance with an embodiment of the present invention.

FIG. 6D presents a state diagram for a branch prediction in speculative-execution mode in accordance with an embodiment of the present invention.

FIG. 6E presents a state diagram for a branch prediction in speculative-execution mode in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Branch Predictor

In one embodiment of the present invention, the branch prediction associated with each branch is recorded in a 2-bit field. Consequently, there are 4 states possible for the branch predictor. The four states (along with their associated bit patterns) are:

| | |
|---|---|
| Strongly-not-taken (SNT 600) | {00} |
| Weakly-not-taken (WNT 601) | {01} |
| Weakly-taken (WT 602) | {10} |
| Strongly-taken (ST 603) | {11}. |

Processor

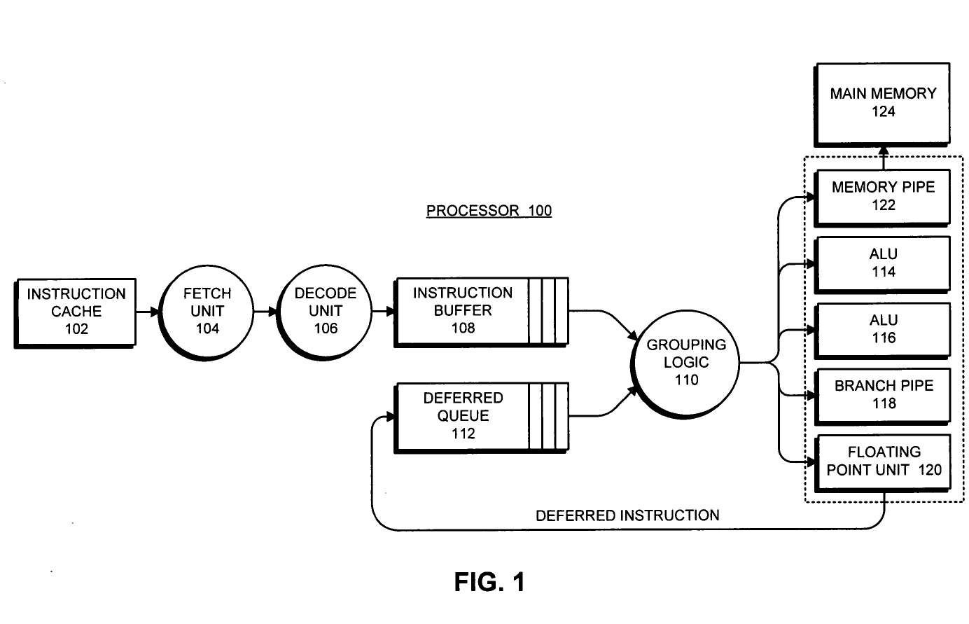

FIG. 1 illustrates the design of a processor 100 that supports speculative-execution in accordance with an embodiment of the present invention. Processor 100 can generally include any type of processor, including, but not limited to, a microprocessor, a mainframe computer, a digital signal processor, a personal organizer, a device controller, and a computational engine within an appliance. As is illustrated in FIG. 1, processor 100 includes: instruction cache 102, fetch unit 104, decode unit 106, instruction buffer 108, deferred queue 112, grouping logic 110, main memory 124, arithmetic logic unit (ALU) 114, ALU 116, branch pipe 118, and floating point unit 120.

During operation, fetch unit 104 retrieves instructions to be executed from instruction cache 102, and feeds these instructions into decode unit 106. Decode unit 106 forwards the instructions to be executed into instruction buffer 108, which is organized as a FIFO buffer. Instruction buffer 108 feeds instructions in program order into grouping logic 110, which groups instructions together and sends them to execution units, including memory pipe 122 (for accessing memory 124), ALU 114, ALU 116, branch pipe 118 (which resolves conditional branch computations), and floating point unit 120.

If an instruction cannot be executed due to an unresolved data dependency, such as an operand that has not returned from a load operation, the system defers execution of the instruction and moves the instruction into deferred queue 112. Note that like instruction buffer 108, deferred queue 112 is also organized as a FIFO buffer.

When the data dependency is eventually resolved, instructions from deferred queue 112 are executed in program order with respect to other deferred instructions, but not with respect to other previously executed non-deferred instructions.

Speculative-Execution State Diagram

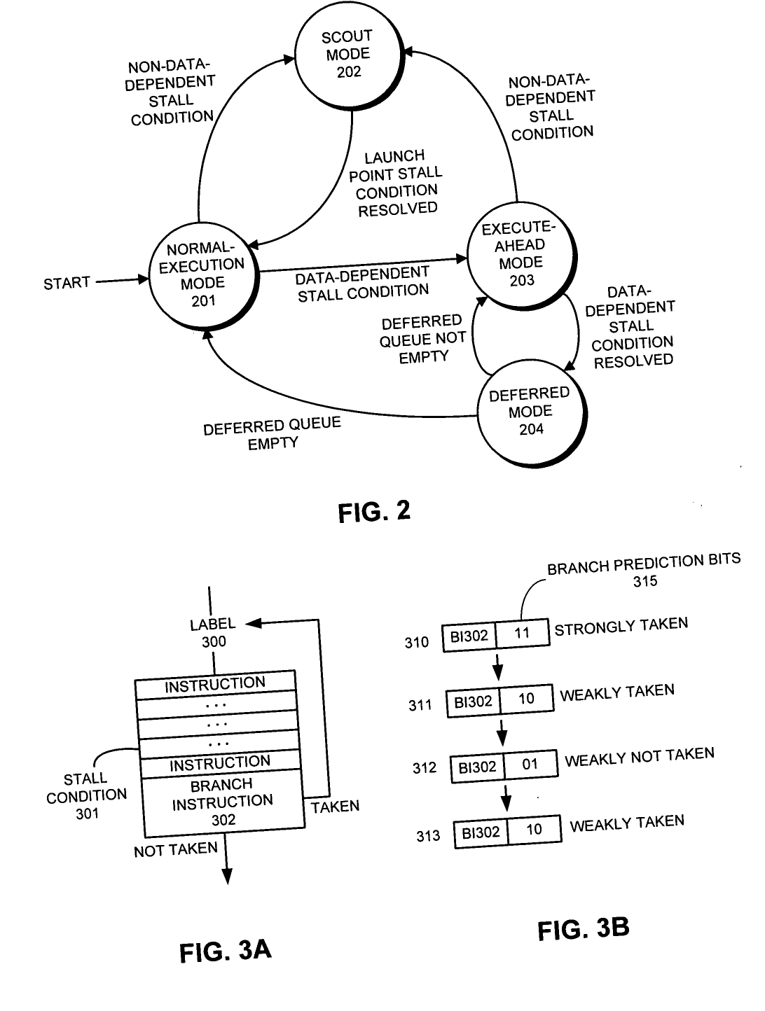

FIG. 2 presents a state diagram which includes a general depiction of execute-ahead mode 203, scout mode 202, and deferred mode 204 in accordance with an embodiment of the present invention.

The system starts in normal-execution mode 201, wherein instructions are executed in program order as they are issued from instruction buffer 108 (see FIG. 1).

Next, if an unresolved data dependency arises during execution of an instruction, the system moves to execute-ahead mode 203. An unresolved data dependency can include: a use of an operand that has not returned from a preceding load miss; a use of an operand that has not returned from a preceding translation lookaside buffer (TLB) miss; a use of an operand that has not returned from a preceding full or partial read-after-write (RAW) from store buffer operation; and a use of an operand that depends on another operand that is subject to an unresolved data dependency.

While moving to execute-ahead mode 203, the system generates a checkpoint that can be used, if necessary, to return execution of the process to the point where the unresolved data dependency was encountered; this point is referred to as the “launch point.” (Note that generating the checkpoint involves saving the precise architectural state of processor 100 to facilitate subsequent recovery from exceptions that arise during execute-ahead mode 203 or deferred mode 204.) The system also “defers” execution of the instruction that encountered the unresolved data dependency by storing the instruction in deferred queue 112.

While operating in execute-ahead mode 203, the system continues to execute instructions in program order as they are received from instruction buffer 108, and any instruction that cannot execute because of an unresolved data dependency is deferred (which involves storing the instruction in deferred queue 112).

During execute-ahead mode 203, if an unresolved data dependency is finally resolved, the system moves into deferred mode 204, wherein the system attempts to execute instructions from deferred queue 112 in program order. Note that the system attempts to execute these instructions in program order with respect to other deferred instructions in deferred queue 112, but not with respect to other previously executed non-deferred instructions (and not with respect to deferred instructions executed in previous passes through deferred queue 112). During this process, the system defers execution of deferred instructions that still cannot be executed because of unresolved data dependencies by placing these again-deferred instruction back into deferred queue 112. On the other hand, the system executes other instructions that can be executed in program order with respect to each other.

After the system completes a pass through deferred queue 112, if deferred queue 112 is empty, the system moves back into normal-execution mode 201. This may involve committing changes made during execute-ahead mode 203 and deferred mode 204 to the architectural state of processor 100, if such changes have not been already committed. The return to normal mode can also involve throwing away the checkpoint generated when the system moved into execute-ahead mode 203.

On the other hand, if deferred queue 112 is not empty after the system completes a pass through deferred queue 112, the system returns to execute-ahead mode 203 to execute instructions from instruction buffer 108 from the point where the execute-ahead mode 203 left off.

If a non-data dependent stall condition (except for a load buffer full or store buffer full condition) arises while the system is in normal-execution mode 201 or execute-ahead mode 203, the system moves into scout mode 202. (This non-data-dependent stall condition can include: a memory barrier operation; or a deferred queue full condition.) In scout mode 202, instructions are speculatively executed to prefetch future loads, but results are not committed to the architectural state of processor 100.

Scout mode 202 is described in more detail in a pending U.S. patent application entitled, “Generating Prefetches by Speculatively Executing Code Through Hardware Scout Threading,” by inventors Shailender Chaudhry and Marc Tremblay, having Ser. No. 10/741,944, and filing date 19 Dec. 2003, which is hereby incorporated by reference to describe implementation details of scout mode 202.

Unfortunately, computational operations performed during scout mode 202 are not committed to the architectural state of the processor, and hence need to be recomputed again upon returning to normal execution mode, which can require a large amount of computational work.

When the original “launch point” stall condition is finally resolved, the system moves back into normal-execution mode 201, and, in doing so, uses the previously generated checkpoint to resume execution from the launch point instruction that encountered the launch point stall condition. The launch point stall condition is the stall condition that originally caused the system to move out of normal-execution mode 201. For example, the launch point stall condition can be the data-dependent stall condition that caused the system to move from normal-execution mode 201 to execute-ahead mode 203, before moving to scout mode 202. Alternatively, the launch point stall condition can be the non-data-dependent stall condition that caused the system to move directly from normal-execution mode 201 to scout mode 202.

Branch Instruction Example

FIG. 3A illustrates a sequence of instructions and FIG. 3B illustrates a corresponding entry in a branch prediction table in accordance with an embodiment of the present invention. These figures illustrate a potential problem with branch prediction in a processor that supports speculative-execution.

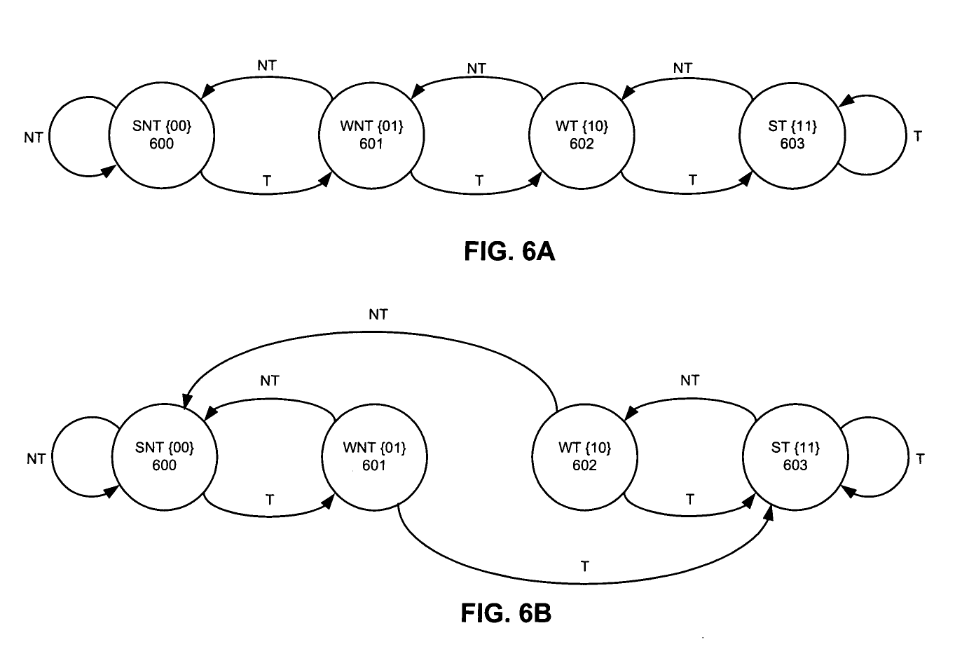

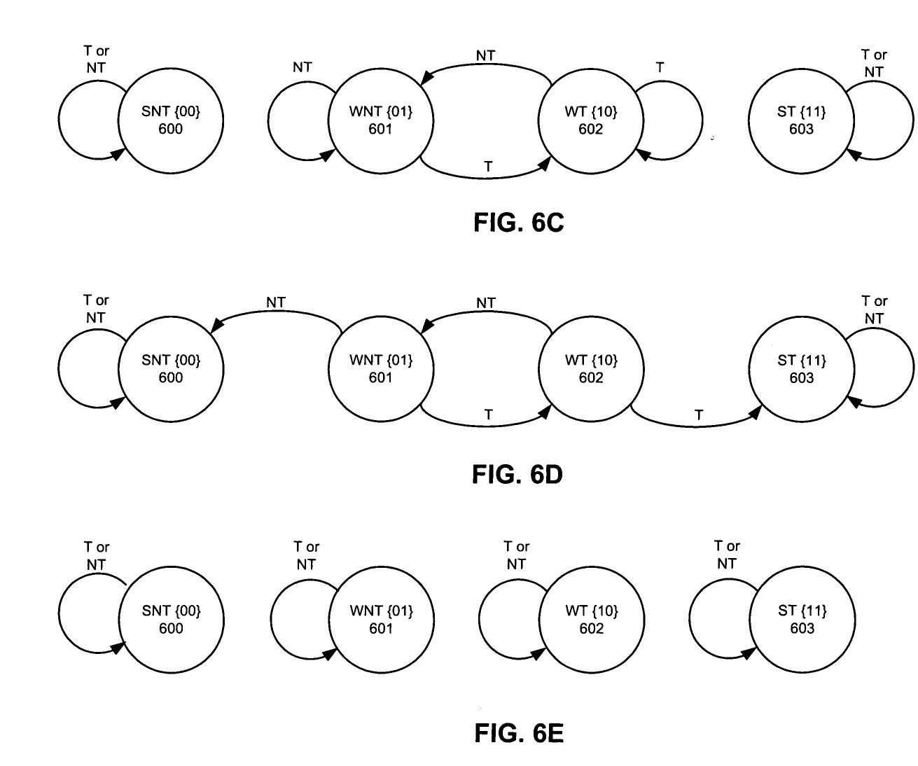

For purposes of illustration, assume that branch instruction 302 is a conditional comparison instruction associated with a FOR loop (hence, when “taking” branch instruction 302, processor 100 jumps back to label 300, thereby creating the loop). Also assume that processor 100 is currently executing instructions, starting at label 300, on the final iteration of the FOR loop and that processor 100 updates branch prediction bits 315 using the normal-execution mode update sequence presented in FIG. 6A.

During this final iteration, processor 100 executes instructions following label 300. Upon encountering stall condition 301, processor 100 generates a checkpoint and enters execute-ahead mode 203 (see FIG. 2).

While subsequently executing instructions within the loop in execute-ahead mode 203, processor 100 executes branch instruction 302. Because processor 100 updated branch prediction bits 315 for branch instruction 302 during earlier “taken” passes around the loop, branch prediction bits 315 are set to predict the branch as strongly-taken (310). Based on this prediction, processor 100 jumps to label 300 and begins to fetch instructions as if beginning another pass around the loop. Since the actual resolution of the branch condition is “not taken” (a loop exit), the branch is mispredicted. Consequently, processor 100 flushes fetch unit 104 and decode unit 106 and begins fetching instructions from the actual resolved location in instruction cache 102. In addition, processor 100 updates the branch prediction to weakly-taken for branch prediction bits 315 (311).

Processor 100 then continues to execute instructions on the “not taken” branch in program order until processor 100 encounters an instruction which leads to a non-data dependent stall condition. Encountering the non-data dependent stall condition causes processor 100 to enter scout-mode 202. Processor 100 subsequently executes instructions in scout-mode 202 awaiting the resolution of the non-data dependent stall condition.

When the non-data dependent stall condition is ultimately resolved, processor 100 uses the checkpoint (generated during the entry to execute-ahead mode 203) to return to normal-execution mode 201 at the instruction that caused stall condition 301.

Upon returning to the checkpoint, processor 100 continues to execute instructions on the final iteration of the loop in normal execution mode, eventually encountering branch instruction 302. Because branch prediction bits 315 are set to weakly-taken, processor 100 jumps to label 300 and starts to fetch instructions as if beginning another pass around the loop. Since the actual resolution of the branch condition is “not taken” (a loop exit), the branch is mispredicted. Consequently, processor 100 flushes fetch unit 104 and decode unit 106 and begins fetching instructions from the actual resolved location in instruction cache 102. In addition, processor 100 updates branch prediction bits 315 to weakly-not-taken (312).

Note that the update during speculative-execution mode followed by the update in normal-execution mode moves the branch prediction from the desired state of weakly-taken to the incorrect weakly-not-taken. If the update had been done correctly, the branch instruction would still be predicted “taken.”

While subsequently executing instructions in normal-execution mode, processor 100 eventually re-enters the loop at label 300 (restarting a new pass through the FOR loop). Processor 100 then executes branch instruction 302, which is predicted weakly-not-taken (312). Based on this prediction, processor 100 fetches instructions as if exiting the loop. Since the actual resolution of the branch condition is “taken” (the loop is not completed), the branch is mispredicted. Consequently, processor 100 flushes fetch unit 104 and decode unit 106 and begins fetching instructions from the actual resolved location in instruction cache 102. In addition, processor 100 updates the branch prediction to weakly-taken for branch prediction bits 315 (313).

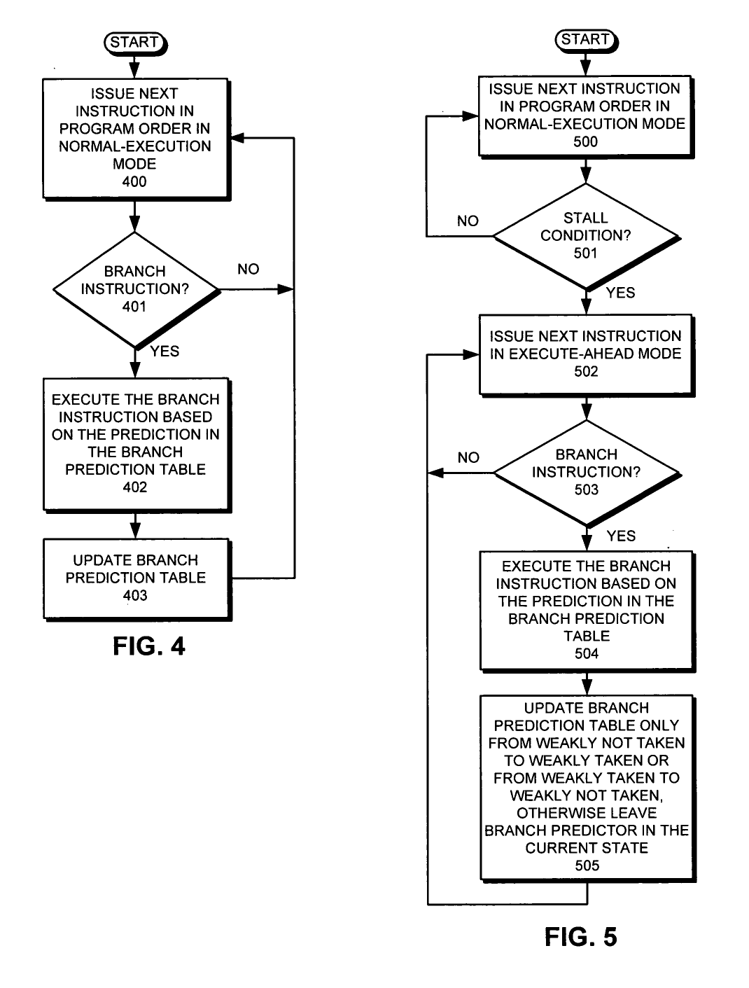

Note that the incorrect weakly-not-taken state of branch prediction bits 315 caused the subsequent misprediction of branch instruction 302. This misprediction in turn cause the delay associated with restarting execution from the actual resolved location of branch instruction 302. Since this situation commonly arises in normal instruction sequences, the duplication of branch updates can cause significant processor performance degradation. This problem can be solved as is described below with reference to FIGS. 4-6E.

Branch Instruction During Normal-Execution Mode

FIG. 4 presents a flow chart illustrating how processor 100 handles a branch instruction during normal-execution mode in accordance with an embodiment of the present invention.

Processor 100 starts by issuing the instructions in program order (step 400). Processor 100 then determines if the instruction is a branch instruction (step 401). If the instruction is not a branch instruction, processor 100 executes the instruction and returns to step 400 to issue the next instruction in program order.

If the instruction is a branch instruction, processor 100 executes the branch instruction (step 402). Depending on the result of the branch instruction, processor 100 may need to jump to a remote memory location to fetch the next instruction for execution. In order to avoid stalling while the result of the branch instruction is calculated, processor 100 predicts the result of the branch instruction using a branch prediction table. Based on the predicted result, processor 100 fetches the next instruction from instruction cache 102.

When processor 100 actually completes the calculations involved in the branch instruction, processor 100 determines if the branch was correctly predicted. If so, processor 100 updates the branch prediction table to reflect the resolution of the branch as predicted (step 403). Processor 100 then returns to step 400 and continues to issue instructions in program order.

If the branch was not correctly predicted, processor 100 flushes fetch unit 104 and decode unit 106 and begins fetching instructions from the actual resolved branch target in instruction cache 102. In addition, processor 100 updates the branch prediction table to reflect the actual resolution of the mispredicted branch (step 403). Processor 100 then returns to step 400 and continues to issue instructions in program order.

Branch Instruction during Speculative-Execution

FIG. 5 presents a flow chart illustrating how processor 100 handles a branch instruction during speculative-execution (and more specifically in execute-ahead mode) in accordance with an embodiment of the present invention.

Processor 100 starts by issuing instructions in program order in normal-execution mode (step 500). Unless the instruction causes a stall condition (step 501), processor 100 returns to step 500 and continues to issue instructions in program order in normal-execution mode.

If the instruction causes a stall condition (step 501), processor 100 enters execute-ahead mode (see FIG. 2). Processor 100 then issues the next instruction in program order in execute-ahead mode (step 502).

Processor 100 next determines if the issued instruction is a branch instruction (step 503). If the instruction is not a branch instruction, processor 100 returns to step 502 and issues the next instruction in program order in execute-ahead mode.

If the instruction is a branch instruction, processor 100 executes the branch instruction (step 504). Depending on the result of the branch instruction, processor 100 may need to jump to a remote memory location to fetch the next instruction for execution. In order to avoid stalling while the result of the branch instruction is calculated, processor 100 predicts the result of the branch instruction using a branch prediction table. Based on the predicted result, processor 100 fetches the next instruction from instruction cache 102.

Processor 100 then performs a limited update of the branch prediction table (step 505). During speculative-execution, processor 100 only updates the branch prediction between the weakly predicted states (WNT 601 and WT 602 as seen in FIG. 6C). Updating the branch prediction in this fashion during speculative-execution avoids the duplication of the branch prediction updates which caused the above-described misprediction problem (see FIGS. 3A-3B).

Upon completing the limited update of the branch prediction, processor 100 returns to step 502 and continues to issue instructions in program order in execute-ahead mode.

Branch Prediction State Diagram During Normal-Execution Mode

FIG. 6A presents a state diagram for a branch prediction in normal-execution mode in accordance with an embodiment of the present invention.

In order to illustrate the transitions between the states of a branch prediction, assume that processor 100 executes a sequence of several hundred instructions, encountering the branch instruction 5 times: processor 100 takes the branch 3 times, does not take the branch once, and finally takes the branch again. In addition, assume that the branch prediction starts in the SNT 600 state for a branch instruction.

The first time that processor 100 encounters the branch instruction, the branch is predicted “not taken” because the branch prediction bits are set to SNT 600. Based on the “not taken” prediction, processor 100 does not jump to the location in memory indicated by the branch instruction, but instead proceeds to fetch the instructions immediately following the branch instruction. Because the actual resolution of the branch instruction is “taken,” the branch is mispredicted. Consequently, processor 100 flushes fetch unit 104 and decode unit 106 and begins to fetch instructions from the target of the branch instruction in instruction cache 102. Processor 100 also updates the state of the branch prediction bits from SNT 600 to WNT 601 (as shown by the “T” path from SNT 600).

The second time that processor 100 encounters the branch instruction, the branch is again predicted “not taken” because the branch prediction bits are set to WNT 601. As in the first pass, since the actual resolution of the branch instruction is “taken,” the branch is mispredicted. Consequently, processor 100 flushes fetch unit 104 and decode unit 106 and begins to fetch instructions from the target of the branch instruction in instruction cache 102. Processor 100 also updates the state of the branch prediction bits from WNT 601 to WT 602 (as shown by the “T” path from WNT 601).

The third time that processor 100 encounters the branch instruction, the branch is predicted “taken” because the branch prediction bits are set to WT 602. Since the branch is “taken,” this is a correct prediction for the branch instruction. Hence, processor 100 begins to fetch instructions from the target of the branch instruction. Processor 100 also updates the state of the branch prediction bits from WT 602 to ST 603 (as shown by the “T” path from WT 602).

The fourth time that processor 100 encounters the branch instruction, the branch is predicted “taken” because the branch prediction bits are set to ST 603. Since the actual resolution of the branch is “not taken,” the branch is mispredicted. Consequently, processor 100 flushes fetch unit 104 and decode unit 106 while continuing to fetch the instructions following the branch instruction in program order. Processor 100 also updates the state of the branch prediction bits from ST 603 to WT 602 (as shown by the “NT” path from ST 603).

The fifth time that processor 100 encounters the branch instruction, the branch is predicted taken because the branch prediction bits are set to WT 602. Since the branch is “taken,” this is a correct prediction for the branch instruction. Hence, processor 100 begins to fetch instructions from the target of the branch instruction. Processor 100 also updates the branch prediction bits from WT 602 to ST 603 (as shown by the “T” branch from WT 602).

Alternative Branch Prediction State Diagram during Normal-execution Mode

FIG. 6B presents a state diagram for a branch prediction in normal-execution mode in accordance with an embodiment of the present invention.

The state transitions in FIG. 6B are similar to FIG. 6A. The difference is the multi-state transitions from the weak states (WNT 601 and WT 602) to the opposing strong states (SNT 600 and ST 603). The branch prediction mechanism uses multi-state transitions to optimize predictions; once the branch prediction algorithm sees two “taken” predictions in a row, there is an assumption that the next two branches will also be “taken.” This effectively gives the branch prediction mechanism a “memory” of the prior resolutions of the branch.

Branch Prediction State Diagram during Speculative-Execution Mode

FIG. 6C presents a state diagram for a branch prediction operation in speculative-execution mode in accordance with an embodiment of the present invention.

During speculative-execution mode, processor 100 does not transition to or from the strongly predicted states (SNT 600 or ST 603). Processor 100 does, however, transition between the two weakly predicted states (WNT 601 or WT 602). By updating the branch prediction in this fashion during speculative-execution, processor 100 avoids possible duplication of updates while retaining some ability to correct mispredictions.

Alternative Branch Prediction State Diagram During Speculative-Execution Mode

FIG. 6D presents a state diagram for a branch prediction operation in speculative-execution mode in accordance with an embodiment of the present invention.

During speculative-execution mode, processor 100 transitions to the strongly predicted states (SNT 600 or ST 603) from the weakly predicted states of the same disposition (WNT 601 or WT 602) and between the two weakly predicted states (WNT 601 or WT 602). Processor 100, however, does not transition out of the strongly predicted states at all during speculative execution. By updating the branch prediction in this fashion during speculative-execution, processor 100 avoids possible duplication of updates while retaining some ability to correct mispredictions.

Second Alternative Branch Prediction State Diagram during Speculative-Execution Mode

FIG. 6E presents a state diagram for a branch prediction operation in speculative-execution mode in accordance with an embodiment of the present invention.

During speculative-execution mode, processor 100 maintains the current branch prediction state, whether the branch is correctly predicted or not. By updating the branch prediction in this fashion during speculative-execution, processor 100 avoids possible duplication of updates and thereby avoids the above-described problems.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for improving branch prediction accuracy in a processor that supports speculative-execution, comprising:
issuing instructions for execution in program order during the execution of a program in a normal-execution mode;
upon encountering a launch condition which causes a processor to enter a speculative-execution mode, performing a checkpoint and commencing execution of instructions in a speculative-execution mode; and
upon encountering a branch instruction during speculative-execution mode,
selecting the subsequent instruction to be executed based on a current state of a branch predictor, and
updating the branch prediction only from weakly-not-taken to weakly-taken or from weakly-taken to weakly-not-taken, thereby preventing the branch predictor from being incorrectly updated twice when re-executing the branch instruction after returning to normal-execution mode.

2. The method of claim 1, further comprising also updating the branch prediction only from weakly-taken to strongly-taken or from weakly-not-taken to strongly-not-taken during speculative-execution mode.

3. The method of claim 1, wherein during normal-execution mode, the processor updates the branch predictor whenever the processor executes the branch instruction.

4. The method of claim 1,
wherein the launch condition is a stall condition; and
wherein the speculative-execution mode is a scout mode, wherein instructions are speculatively executed to prefetch future loads, but wherein results are not committed to the architectural state of the processor.

5. The method of claim 4, wherein the stall condition can include:
a load miss stall;
a store buffer full stall; and
a memory barrier stall.

6. The method of claim 1,
wherein the launch condition is an unresolved data dependency encountered while executing the launch-point instruction; and
wherein the speculative-execution mode is an execute-ahead mode, wherein instructions that cannot be executed because of an unresolved data dependency are deferred, and wherein other non-deferred instructions are executed in program order.

7. The method of claim 6, wherein the unresolved data dependency can include:
a use of an operand that has not returned from a preceding load miss;
a use of an operand that has not returned from a preceding translation lookaside buffer (TLB) miss;
a use of an operand that has not returned from a preceding full or partial read-after-write (RAW) from store buffer operation; and
a use of an operand that depends on another operand that is subject to an unresolved data dependency.

8. The method of claim 1, wherein the processor returns to normal-execution mode when the processor encounters a condition causing the processor to exit speculative-execution mode.

9. An apparatus that improves branch prediction accuracy in a processor that supports speculative-execution, comprising:
an execution mechanism within the processor;
wherein the execution mechanism is configured to issue instructions for execution in program order during execution of a program in a normal-execution mode;
upon encountering a launch condition which causes the execution mechanism to enter a speculative-execution mode, the execution mechanism is configured to perform a checkpoint and commence execution of instructions in a speculative-execution mode;
wherein upon encountering a branch instruction during speculative-execution mode, the execution mechanism is configured to,
select the subsequent instruction based on a current state of a branch prediction, and to
update the branch prediction from weakly-not-taken to weakly-taken or from weakly-taken to weakly-not-taken, thereby preventing the branch predictor from being incorrectly updated twice when re-executing the branch instruction after returning to normal-execution mode.

10. The apparatus of claim 9, wherein the execution mechanism is further configured to also update the branch prediction from weakly-taken to strongly-taken or from weakly-not-taken to strongly-not-taken during speculative-execution mode.

11. The apparatus of claim 9, wherein during normal-execution mode, the execution mechanism is configured to update the branch predictor whenever the processor executes the branch instruction.

12. The apparatus of claim 9,
wherein the launch condition is a stall condition; and
wherein the speculative-execution mode is a scout mode, wherein the execution mechanism is configured to speculatively execute instructions to prefetch future loads, but not to commit the results to the architectural state of the processor.

13. The apparatus of claim 12, wherein the stall condition can include:
a load miss stall;
a store buffer full stall; and
a memory barrier stall.

14. The apparatus of claim 9,
wherein the launch condition is an unresolved data dependency encountered while executing the launch-point instruction; and
wherein the speculative-execution mode is an execute-ahead mode, wherein the execution mechanism is configured to defer instructions that cannot be executed because of an unresolved data dependency, and execute other non-deferred instructions in program order.

15. The apparatus of claim 14, wherein the unresolved data dependency can include:
a use of an operand that has not returned from a preceding load miss;
a use of an operand that has not returned from a preceding translation lookaside buffer (TLB) miss;
a use of an operand that has not returned from a preceding full or partial read-after-write (RAW) from store buffer operation; and
a use of an operand that depends on another operand that is subject to an unresolved data dependency.

16. The apparatus of claim 9, wherein when encountering a condition causing the execution mechanism to exit speculative-execution mode, the execution mechanism returns to normal-execution mode.

17. An apparatus that improves branch prediction accuracy in a processor that supports speculative-execution, comprising:
an execution mechanism within the processor;
wherein the execution mechanism is configured to issue instructions for execution in program order during execution of a program in a normal-execution mode;
upon encountering a launch condition which causes the execution mechanism to enter a speculative-execution mode, the execution mechanism is configured to perform a checkpoint and commence execution of instructions in a speculative-execution mode;
wherein upon encountering a branch instruction during speculative-execution mode, the execution mechanism is configured to,
select the subsequent instruction based on a current state of a branch prediction, and to
leave the branch predictor in the current state, thereby preventing the branch predictor from being incorrectly updated twice when re-executing the branch instruction after returning to normal-execution mode.

18. The apparatus of claim 17, wherein during normal-execution mode, the execution mechanism is configured to update the branch predictor whenever the processor executes the branch instruction.

19. The apparatus of claim 17,
wherein the launch condition is a stall condition; and
wherein the speculative-execution mode is a scout mode, wherein the execution mechanism is configured to speculatively execute instructions to prefetch future loads, but not to commit the results to the architectural state of the processor.

20. The apparatus of claim 17, wherein the stall condition can include:
a load miss stall;
a store buffer full stall; and
a memory barrier stall.
